(19) United States
(12) Patent Application Publication
(10) Pub. No.: US 2020/0369125 A1
(43) Pub. Date: Nov. 26, 2020

(54) INFORMATION PROCESSING SYSTEM AND INFORMATION PROCESSING METHOD

(71) Applicant: TOYOTA JIDOSHA KABUSHIKI KAISHA, Toyota-shi (JP)

(72) Inventors: Yuta ISHIKO, Ama-gun (JP); Kazuyuki ISHIWATA, Toyota-shi (JP)

(73) Assignee: TOYOTA JIDOSHA KABUSHIKI KAISHA, Toyota-shi (JP)

(21) Appl. No.: 16/857,263

(22) Filed: Apr. 24, 2020

(30) Foreign Application Priority Data
May 23, 2019 (JP) 2019-097022

(51) Int. Cl. B60H 3/00; G06Q 10/02; G06Q 50/10

(52) U.S. Cl. CPC B60H 3/0085; G06Q 50/10; G06Q 10/02

(57) ABSTRACT

In an information processing system, a strength acquiring unit acquires the strength of odor in a vehicle cabin of a vehicle. When the acquired strength of odor is equal to or higher than a threshold value, an output unit outputs information for requesting cleaning of the vehicle. A type acquiring unit acquires the type of odor in the vehicle cabin. When the acquired strength of odor is equal to or higher than the threshold value, a cleaning action determination unit determines a cleaning action for the vehicle based on the acquired type of odor. The information for requesting cleaning includes the cleaning action.

### INCORPORATION BY REFERENCE

The disclosure of Japanese Patent Application No. 2019-097022 filed on May 23, 2019 including the specification, drawings and abstract is incorporated herein by reference in its entirety.

### BACKGROUND

### 1. Technical Field

The present disclosure relates to a technique for processing information on odor in a vehicle cabin of a vehicle.

### 2. Description of Related Art

Vehicle air purification devices for eliminating remaining odor in a vehicle cabin are known (see Japanese Patent Application Publication 2004-168074, for instance). The device described in JP 2004-168074 A detects odor in the vehicle cabin with an odor sensor before occupants get on the vehicle, and if odor is present, eliminates the odor with an air purifier and also activates a fragrance generator to emit pleasant smell.

### SUMMARY

When relatively strong odor of cigarettes and the like is present in the vehicle cabin, the odor can remain even with the activation of the air purifier and the fragrance generator in the vehicle cabin.

In view of these situations, the present disclosure provides an information processing system and an information processing method that can address relatively strong odor or odor that takes time to be addressed in the vehicle cabin of a vehicle.

To that end, an information processing system according one aspect of the present disclosure includes: a strength acquiring unit that acquires a strength of odor in a vehicle cabin of a vehicle; and an output unit that, when the acquired strength of odor is equal to or higher than a threshold value, outputs information for requesting cleaning of the vehicle.

According to this aspect, cleaning can be easily requested via information for requesting cleaning of the vehicle when odor in the vehicle cabin is relatively strong.

The information processing system may include: a type acquiring unit that acquires a type of odor in the vehicle cabin; and a cleaning action determination unit that, when the acquired strength of odor is equal to or higher than the threshold value, determines a cleaning action for the vehicle based on the acquired type of odor. The information for requesting cleaning may include the cleaning action.

The information processing system may include: a reservation information acquiring unit that acquires reservation information of the vehicle shared by a plurality of users, reservation information of an alternative vehicle for the vehicle, and a schedule of a cleaning person to clean the vehicle; and a cleaning timing determination unit that, when the acquired strength of odor is equal to or higher than the threshold value, determines a cleaning timing for the vehicle based on the reservation information of the vehicle, the reservation information of the alternative vehicle, and the schedule of the cleaning person that have been acquired. The information for requesting cleaning may include the cleaning timing.

The information processing system may include a notification unit that, when the acquired strength of odor is less than the threshold value and when a condition indicating that the odor remains in the vehicle cabin is satisfied, notifies a next reservation holder for the vehicle identified from the reservation information of the vehicle of the presence of the odor.

The information processing system may include a granting unit that grants an incentive to the next reservation holder when the notification unit notifies the next reservation holder of the presence of the odor.

The information processing system may include a derivation unit that, when the acquired strength of odor is equal to or higher than the threshold value, derives a score for a user who left the odor identified from the reservation information of the vehicle.

The information for requesting cleaning may include information on a cleaning service provider.

Another aspect of the present disclosure is an information processing method. The method includes: a strength acquiring step of acquiring a strength of odor in a vehicle cabin of a vehicle; and an outputting step of, when the acquired strength of odor is equal to or higher than a threshold value, outputting information for requesting cleaning of the vehicle.

The present disclosure can address relatively strong odor or odor that takes time to be addressed in the vehicle cabin of a vehicle.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 shows a functional configuration of an information processing system according to an embodiment; and

FIG. 2 is a flowchart illustrating processing in the information processing system of FIG. 1.

### DETAILED DESCRIPTION OF EMBODIMENTS

The information processing system according to an embodiment is applied to a car sharing service for lending out vehicles to users as an example. In a car sharing service, a vehicle is shared by a number of users and a user gets on a vehicle parked in a car station when he/she starts utilizing the service and returns the vehicle to the same car station when the user ends the utilization of the service. A car sharing service is a service that does not involve staff as an intermediate at the start and end of utilization of the service by a user, so no staff is deployed at car stations. Thus, whether there is odor in the vehicle cabin of a vehicle is not checked on each return of the vehicle. Consequently, if there is relatively strong odor remaining in the vehicle cabin of a returned vehicle, the next user would utilize the vehicle with the remaining odor and likely have complaints. As mentioned earlier, if the odor is strong, the odor may not be sufficiently eliminated with operation of an air purifier in the vehicle cabin.

In this embodiment, accordingly, odor in the vehicle cabin of a returned vehicle is detected with a sensor and a cleaning person is requested to clean the vehicle cabin if the odor is relatively strong.

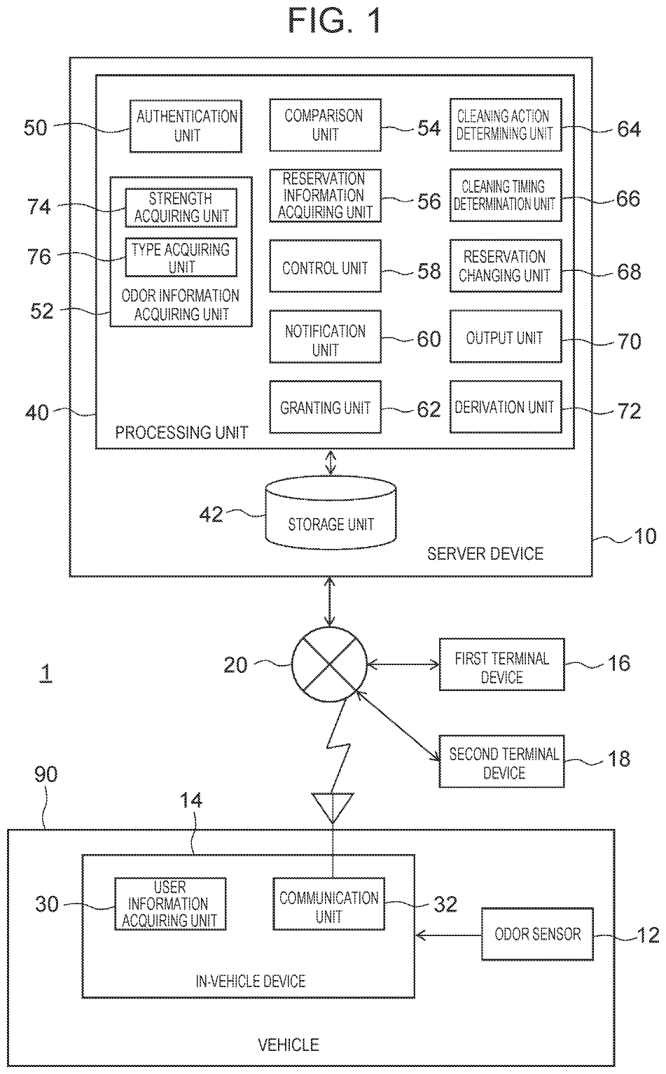

FIG. 1 shows a functional configuration of an information processing system 1 according to this embodiment. The information processing system 1 includes a server device 10, an odor sensor 12, an in-vehicle device 14, a first terminal device 16, and a second terminal device 18.

The odor sensor 12 and the in-vehicle device 14 are mounted on a vehicle 90, which is an automobile. The in-vehicle device 14 has wireless communication functions and connects to a network 20 via a wireless base station or a wireless access point.

The first terminal device 16 is managed by a cleaning service provider for vehicles. The cleaning service provider may be the same as a provider of the car sharing service or a different cleaning business operator than the provider of the car sharing service. The second terminal device 18 is utilized by a user who utilizes the car sharing service. The first terminal device 16 and the second terminal device 18 connect to the network 20 over wireless or wired communication.

The server device 10 is connected with the network 20, and the server device 10 performs communication with the in-vehicle device 14, the first terminal device 16 and the second terminal device 18 by way of the network 20. The server device 10 is managed by the provider of the car sharing service.

While FIG. 1 shows only a single second terminal device 18 and a single vehicle 90, the car sharing service are operated with multiple users and multiple vehicles 90. The information processing system 1 thus includes multiple second terminal devices 18 and multiple in-vehicle devices 14.

The in-vehicle device 14 includes a user information acquiring unit 30 and a communication unit 32. The server device 10 includes a processing unit 40 and a storage unit 42. The processing unit 40 includes an authentication unit 50, an odor information acquiring unit 52, a comparison unit 54, a reservation information acquiring unit 56, a control unit 58, a notification unit 60, a granting unit 62, a cleaning action determination unit 64, a cleaning timing determination unit 66, a reservation changing unit 68, an output unit 70, and a derivation unit 72.

Configurations of the server device 10 and the in-vehicle device 14 may be embodied by CPUs of certain computers, memories, and other LSIs in terms of hardware and by programs loaded in the memories and the like in terms of software;

however, functional blocks embodied by cooperation of them are depicted herein. Thus, it will be appreciated by those skilled in the art that these functional blocks may be embodied in various manners including solely by hardware, solely by software, or any combination thereof.

When a user starts utilizing the vehicle 90, the user information acquiring unit 30 of the in-vehicle device 14 acquires user information from a portable device or a membership card carried by the user, for example, and transmits the acquired user information to the authentication unit 50 of the server device 10 through the communication unit 32. The user information includes a user ID and authentication information such as a password. The user information being transmitted additionally contains an ID of the vehicle 90 on which the in-vehicle device 14 is mounted.

Upon receiving the user information, the server device 10 performs authentication of the user. The storage unit 42 of the server device 10 stores the authentication information for the user in association with the user ID. The storage unit 42 also stores, for each vehicle ID, reservation information of the vehicle 90 associating a reservation start date/time, a reservation end date/time, and the user ID of the user who made a reservation with each other.

When a reservation with the current date and time related to the transmitted user ID is present in the reservation information of the vehicle ID that was sent from the in-vehicle device 14 and if the transmitted authentication information matches the stored authentication information, the authentication unit 50 gives a successful authentication and sends a notification of authentication completion to the in-vehicle device 14. With the completion of user authentication, the in-vehicle device 14 makes the vehicle 90 available for driving.

When the user ends the utilization of the vehicle 90, the user information acquiring unit 30 again acquires user information from the user and transmits the user information to the authentication unit 50 of the server device 10 via the communication unit 32.

If the transmitted authentication information matches the stored authentication information with authentication already completed for the vehicle ID that was sent from the in-vehicle device 14, the authentication unit 50 sends a notification on completion of vehicle return to the in-vehicle device 14.

The start and end of utilization of the vehicle 90 can be determined using any of various known techniques aside from the foregoing example of processing.

The odor sensor 12 is attached to a ceiling of the vehicle cabin of the vehicle 90, for example. A location of attachment of the odor sensor 12 is not specifically limited and can be any position where odor in the vehicle cabin can be detected, such as on a dash board. When a notification on completion of vehicle return is received by the communication unit 32, that is, the utilization of the vehicle 90 by the user has ended, the odor sensor 12 detects odor in the vehicle cabin and outputs resulting odor data to the communication unit 32. The communication unit 32 transmits the odor data to the server device 10. The odor data being transmitted additionally contains the vehicle ID.

The odor information acquiring unit 52 of the server device 10 receives the odor data, derives odor information based on the odor data, and acquires the derived odor information. The odor information includes a strength of odor in the vehicle cabin of the vehicle 90, a type of odor and the like.

The odor information acquiring unit 52 has a strength acquiring unit 74 and a type acquiring unit 76. The strength acquiring unit 74 acquires the strength of odor based on the odor data and outputs the strength of odor to the comparison unit 54. The type acquiring unit 76 acquires the type of odor based on the odor data and outputs the type of odor to the cleaning action determination unit 64. The type of odor includes odor of cigarettes, odor of food, and odor of pets, for example. For acquisition of the strength and type of odor, any of known techniques may be employed.

The comparison unit 54 compares the acquired strength of odor with a first threshold value, a second threshold value and a third threshold value. The second threshold value is greater than the first threshold value and the third threshold value is greater than the second threshold value. The first through third threshold values can be defined as appropriate such as by experiment.

When the strength of odor is less than the first threshold value, the server device 10 determines that substantially no odor is present and continues the car sharing service for the vehicle 90.

When the strength of odor is equal to or higher than the first threshold value, the notification unit 60 notifies a terminal device (not shown) of a manager of the car sharing service of the presence of odor and the vehicle ID.

When the strength of odor is equal to or higher than the first threshold value, the server device 10 performs processing in different manners depending on the strength of odor as described below in (1) to (3).

(1) When the strength of odor is equal to or higher than the first threshold value and less than the second threshold value, the strength of odor is low. The server device 10 continues the car sharing service for the vehicle 90 assuming that the presence of the odor is not problematic.

(2) When the strength of odor is equal to or higher than the second threshold value and less than the third threshold value, the strength of odor is middle; the odor is likely to be mitigated only with an air conditioner (not shown) on the vehicle 90.

The reservation information acquiring unit 56 acquires the reservation information of the vehicle 90 from the storage unit 42 and outputs the reservation information to the control unit 58 and the notification unit 60.

If there is no next reservation within a predetermined air purification duration from the current time in the reservation information of the vehicle 90, the control unit 58 operates an air conditioner having air purification functions mounted on the vehicle 90 for the air purification duration via the communication unit 32 of the in-vehicle device 14. This can eliminate or mitigate the odor in the vehicle cabin. The air purification duration is an amount of time that can allow the strength of odor to decrease below the second threshold value with the operation of the air conditioner. It may be several minutes to over ten minutes, for example, and may be defined as appropriate such as by experiment. The air purification duration may also be established according to a model of the vehicle 90, such as depending on a size of the vehicle cabin. In addition to operating the air conditioner, the control unit 58 may also cause a fragrance generator (not shown) mounted on the vehicle 90 to emit pleasant smell. With the pleasant smell, the odor can be mitigated more efficiently.

When there is a next reservation for the vehicle 90 within the air purification duration from the current time, the notification unit 60 notifies the second terminal device 18 of the next reservation holder for the vehicle 90 identified from the reservation information of the vehicle 90 of the presence of odor. This process is equivalent to the notification unit 60 notifying the second terminal device 18 of the next reservation holder for the vehicle 90 of the presence of odor in a case where the acquired strength of odor is less than the third threshold value and if a remnant condition indicative of remaining odor in the vehicle cabin is satisfied. The remnant condition is that the strength of odor is equal to or higher than the second threshold value and there is a next reservation for the vehicle 90 within the air purification duration from the current time. In this manner, the next reservation holder for the vehicle 90 can be informed of remaining odor if there is any. When there is a next reservation within the air purification duration from the current time, the control unit 58 may also operate the air conditioner until the reservation start time of the next reservation.

In the case of the notification unit 60 notifying the next reservation holder of the presence of odor, the granting unit 62 grants an incentive to the next reservation holder. The granting unit 62 stores the incentive in the storage unit 42 in association with the user ID of the next reservation holder. The incentive is a discount of a fee for the car sharing service or a point that can be used for purchasing items or the like at various stores, for example. The incentive may also be a coupon or a ticket that provides a similar effect to a point. The granting unit 62 may determine the incentive such that the user will get greater benefit as the strength of odor is higher. The notification unit 60 may also notify the second terminal device 18 of the next reservation holder that the incentive has been granted. The incentive can mitigate possible complaints of the next reservation holder even if the odor still remains when he/she utilizes the vehicle 90.

(3) When the strength of odor is equal to or higher than the third threshold value, the strength of odor is high. The odor probably cannot be sufficiently mitigated only with the air conditioner of the vehicle 90, so that cleaning of the vehicle cabin by a cleaning person is arranged.

When the acquired strength of odor is equal to or higher than the third threshold value, the cleaning action determination unit 64 determines cleaning actions for the vehicle 90 based on the type of odor acquired by the type acquiring unit 76. The cleaning actions are predefined for each type of odor. When the type of odor is odor of cigarettes, the cleaning actions can include air purification with an air conditioner, odor elimination with a cigarette odor eliminator, and wiping of an interior of the vehicle cabin, for example. When the type of odor is odor of food, the cleaning actions can include air purification with an air conditioner and removal of food scraps with a vacuum cleaner, for example. The type of odor may include any other type of odor, such as odor of pets. The cleaning actions may be defined as appropriate such as by experiment per type of odor such that they provide high odor eliminating effect.

The reservation information acquiring unit 56 acquires the reservation information of the vehicle 90 and the reservation information of an alternative vehicle for the vehicle 90 from the storage unit 42, and acquires a schedule of the cleaning person to clean the vehicle 90 from the first terminal device 16.

When the acquired strength of odor is equal to or higher than the third threshold value, the cleaning timing determination unit 66 determines a cleaning timing for the vehicle 90 based on the reservation information of the vehicle 90, the reservation information of the alternative vehicle, and the cleaning person's schedule. The cleaning timing may be determined in the following manner, for example, though not limited thereto.

If there is no reservation for the vehicle 90 during a cleaning period from the current time to an expected end time of cleaning, the cleaning timing determination unit 66 sets a time after the current time at which the cleaning person is available as the cleaning timing. The expected end time of cleaning is a time after elapse of a predefined amount of time required for cleaning from a time at which the cleaning person is available.

The time required for cleaning may be derived based on the type of odor and the strength of odor. If the cleaning person is available at the current time, the current time is set as the cleaning timing.

When there is a reservation for the vehicle 90 in the cleaning period and if an alternative vehicle is available, the cleaning timing determination unit 66 sets a time at which the cleaning person is available as the cleaning timing and the reservation changing unit 68 change the reservation for the vehicle 90 in the cleaning period to a reservation for the alternative vehicle. The service for the vehicle 90 is temporarily stopped. In this way, the user who has reserved the vehicle 90 can use the alternative vehicle and cleaning can be done with less disadvantage for the user.

When there is a reservation for the vehicle 90 in the cleaning period and if an alternative vehicle is not available, the cleaning timing determination unit 66 sets a time at which the cleaning person is available as the cleaning timing and the reservation changing unit 68 cancels the reservation for the vehicle in the cleaning period. In this case, the service for the vehicle 90 is also temporarily stopped. Thus, when an alternative vehicle is not available, cleaning of the vehicle 90 can be given priority to prevent the vehicle 90 with strong remaining odor from being used by the user.

Alternatively, when there is a reservation for the vehicle 90 in the cleaning period and if an alternative vehicle is not available and the cleaning person is available at the current time, the cleaning timing determination unit 66 may set the current time as the cleaning timing and the cleaning action determination unit 64 may determine cleaning actions indicating that cleaning should be finished by the reservation start time for the vehicle 90. In this case, the odor might remain because cleaning is performed in a shorter time but the odor can be mitigated to some degree, and the user's reservation can be given higher priority when no alternative vehicle is available, allowing the user to utilize the vehicle 90.

Alternatively, when there is a reservation for the vehicle 90 in the cleaning period and if an alternative vehicle is not available, the cleaning timing determination unit 66 may set as the cleaning timing a time at which the cleaning person is available after the reservation end time for the vehicle 90. In this case, the user's reservation can be given higher priority when no alternative vehicle is available, allowing the user to utilize the vehicle 90. In this case, the granting unit 62 may grant an incentive to the user. The incentive can mitigate possible complaints of the user who utilizes the vehicle 90 with odor.

When the acquired strength of odor is equal to or higher than the third threshold value, the output unit 70 outputs information for requesting the cleaning person to clean the vehicle 90 to the first terminal device 16. The information for requesting cleaning of the vehicle 90 includes the information on the vehicle to be cleaned, the cleaning actions for the vehicle 90 determined by the cleaning action determination unit 64, and the cleaning timing determined by the cleaning timing determination unit 66. The information on the vehicle to be cleaned is associated with the vehicle ID in advance and includes a car number (license number) of the vehicle 90, the model of the vehicle 90, and a location of the car station where the vehicle 90 is parked.

After receiving the information, the first terminal device 16 displays the information on the vehicle to be cleaned, the cleaning actions and the cleaning timing. An employee at the cleaning service who has seen the display on the first terminal device 16 gives instructions to the cleaning person and the cleaning person cleans the vehicle of interest at the cleaning timing displayed and with the cleaning actions displayed.

In this manner, when odor in the vehicle cabin is relatively strong, cleaning can be easily requested via information for requesting cleaning of the vehicle 90. Thus, the relatively strong odor in the vehicle cabin can be addressed. Further, since cleaning actions suitable for the type of odor can be provided to the cleaning person, the cleaning person can clean the vehicle 90 efficiently and economically and mitigation of odor is facilitated regardless of the cleaning person's skill. It is also possible to clean the vehicle at an appropriate timing to suit a reservation status of the vehicle 90, availability status of the cleaning person, and availability status of an alternative vehicle.

When the strength of odor is equal to or higher than the second threshold value, the derivation unit 72 derives a score for the user who left the odor identified from the reservation information of the vehicle 90. The derived score is a negative score, for example, and the score when the strength of odor is equal to or higher than the third threshold value may be lower than the score when the strength of odor is equal to or higher than the second threshold value and less than the third threshold value. The derivation unit 72 stores the score in the storage unit 42 in association with the user ID.

With such scores, users who left odor of medium or high strength can be recorded. Then, a penalty according to the score, such as setting a higher fee, can be given to a user who left odor next time the user utilizes the car sharing service. In some cases, a user who left odor of high strength could be charged for a cleaning cost.

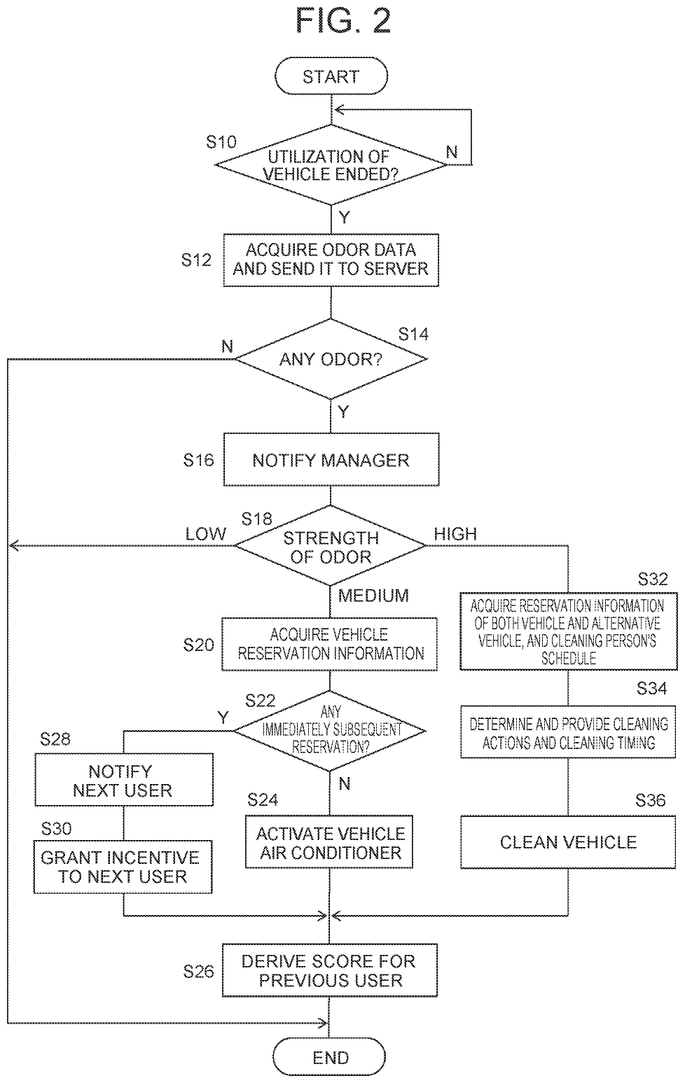

FIG. 2 is a flowchart illustrating processing in the information processing system 1 of FIG. 1. The processing of FIG. 2 is performed every time a user starts utilization of the vehicle 90. When the utilization of the vehicle 90 by the user has not finished (N at S10), the flow returns to S10. When the utilization of the vehicle 90 has finished (Y at S10), the odor sensor 12 acquires odor data and the communication unit 32 sends the odor data to the server device 10 (S12).

If there is no odor (N at S14), the processing ends. If there is odor (Y at S14), the notification unit 60 notifies the manager of the car sharing service that odor is present (S16), and when the strength of odor is low (S18), the processing ends.

When the strength of odor is medium (S18), the reservation information acquiring unit 56 acquires the reservation information of the vehicle (S20). If there is no immediately subsequent reservation (N at S22), the control unit 58 activates the air conditioner of the vehicle 90 (S24), the derivation unit 72 derives a score for the previous user (S26), and the processing ends. If there is an immediately subsequent reservation (Y at S22), the notification unit 60 notifies the next user of the presence of odor (S28), the granting unit 62 grants an incentive to the next user (S30), and the flow proceeds to S26.

When the strength of odor is high (S18), the reservation information acquiring unit 56 acquires the reservation information of both the vehicle 90 and an alternative vehicle and the schedule of the cleaning person (S32), the cleaning actions determination unit 64 determines the cleaning actions for the vehicle, the cleaning timing determination unit 66 determines the cleaning timing, and the output unit 70 outputs the cleaning actions and the cleaning timing (S34). The cleaning person cleans the vehicle 90 in accordance with the cleaning actions and the cleaning timing (S36), and the flow proceeds to S26.

The present disclosure has been described with reference to an embodiment. It will be appreciated by those skilled in the art that the embodiment is merely illustrative and different variations are possible in combinations of components or processing processes and that such variations also fall within the scope of the present disclosure.

For example, the comparison unit 54 may compare the strength of odor with the threshold values when the acquired type of odor is a predefined type, and may not compare the strength of odor with the threshold values if the acquired type of odor is not a predefined type. In this variation, only predefined types of odor, such as odor of cigarettes, can be addressed.

While in the above embodiment the server device 10 includes the odor information acquiring unit 52 and the comparison unit 54, they may be provided in the in-vehicle device 14. In that case, the in-vehicle device 14 sends a result of comparison by the comparison unit 54 to the server device 10 and the server device 10 performs the processing of the embodiment using the result of comparison it received. In this variation, the information processing system 1 can have an increased degree of freedom in configuration.

The information processing system 1 may also be applied to an unmanned bus operation service instead of a car sharing service. In that case, the vehicle 90 in the above embodiment corresponds to an autonomously driving bus. At the server device 10, processing involved when the strength of odor is equal to or higher than the second threshold value and less than the third threshold value as well as reservation information of the vehicle and an alternative vehicle are not necessary. The odor sensor 12 performs detection of odor when the bus has returned to a waiting location such as a bus depot or when there is no passenger in the bus in service. When the strength of odor is equal to or higher than the third threshold value, the cleaning timing determination unit 66 determines the cleaning timing based on the schedule of the cleaning person. When the acquired strength of odor is equal to or higher than the third threshold value, the output unit 70 outputs the cleaning timing and the cleaning actions to the first terminal device 16 and requests cleaning. In a case where cleaning is requested when there is no passenger, the bus stops its service and returns to the waiting location and the like.

The information processing system 1 is also applicable to individual vehicles such as private owned vehicles and taxis instead of a car sharing service or an unmanned bus operation service. In such a case, the odor information acquiring unit 52, the comparison unit 54 and the output unit 70 of the server device 10 will be located in the in-vehicle device 14 and the server device 10 will not be provided. The communication unit 32 may not be provided. The odor information acquiring unit 52 periodically acquires information on odor in the vehicle cabin of the vehicle 90. The comparison unit 54 compares the acquired strength of odor with the third threshold value. When the strength of odor is equal to or higher than the third threshold value, the output unit 70 outputs information for requesting cleaning of the vehicle 90 including information on the cleaning service provider to an occupant of the vehicle 90. For example, for the information on the cleaning service provider, the output unit 70 may display a contact of the cleaning service provider such as telephone number in the form of text, or may display a QR code (a registered trademark) including information on a URL (Uniform Resource Locator) of the cleaning service provider. Based on the output information, the occupant on the vehicle 90 can easily request cleaning from the cleaning service provider.

What is claimed is:

1. An information processing system comprising:
a strength acquiring unit that acquires a strength of odor in a vehicle cabin of a vehicle; and
an output unit that, when the acquired strength of odor is equal to or higher than a threshold value, outputs information for requesting cleaning of the vehicle.

2. The information processing system according to claim 1, comprising:
a type acquiring unit that acquires a type of odor in the vehicle cabin; and
a cleaning action determination unit that, when the acquired strength of odor is equal to or higher than the threshold value, determines a cleaning action for the vehicle based on the acquired type of odor,
wherein the information for requesting cleaning includes the cleaning action.

3. The information processing system according to claim 1, comprising:
a reservation information acquiring unit that acquires reservation information of the vehicle shared by a plurality of users, reservation information of an alternative vehicle for the vehicle, and a schedule of a cleaning person to clean the vehicle; and
a cleaning timing determination unit that, when the acquired strength of odor is equal to or higher than the threshold value, determines a cleaning timing for the vehicle based on the reservation information of the vehicle, the reservation information of the alternative vehicle, and the schedule of the cleaning person that have been acquired;
wherein the information for requesting cleaning includes the cleaning timing.

4. The information processing system according to claim 3, comprising a notification unit that, when the acquired strength of odor is less than the threshold value and when a condition indicating that the odor remains in the vehicle cabin is satisfied, notifies a next reservation holder for the vehicle identified from the reservation information of the vehicle of the presence of the odor.

5. The information processing system according to claim 4, comprising a granting unit that grants an incentive to the next reservation holder when the notification unit notifies the next reservation holder of the presence of the odor.

6. The information processing system according to claim 3, comprising a derivation unit that, when the acquired strength of odor is equal to or higher than the threshold value, derives a score for a user who left the odor identified from the reservation information of the vehicle.

7. The information processing system according to claim 1, wherein the information for requesting cleaning includes information on a cleaning service provider.

8. An information processing method comprising:
a strength acquiring step of acquiring a strength of odor in a vehicle cabin of a vehicle; and
an outputting step of, when the acquired strength of odor is equal to or higher than a threshold value, outputting information for requesting cleaning of the vehicle.
